(19) United States
(12) Patent Application Publication
(10) Pub. No.: US 2025/0309710 A1
(43) Pub. Date: Oct. 2, 2025

(54) ROTOR AND ROTARY ELECTRIC MACHINE

(71) Applicant: NIDEC CORPORATION, Kyoto (JP)

(72) Inventors: Yabo HU, Kyoto (JP); Tomoya UEDA, Kyoto (JP)

(21) Appl. No.: 19/092,192

(22) Filed: Mar. 27, 2025

(30) Foreign Application Priority Data
Mar. 29, 2024 (JP) 2024-056667

(51) Int. Cl. H02K 1/2783

(52) U.S. Cl. CPC H02K 1/2783

(57) ABSTRACT

A rotor provided in a rotary electric machine, opposed to a stator, and rotatable about a central axis, includes magnetic pole portions arranged circumferentially about the central axis, and a rotor core that supports the magnetic pole portions from radial one side. Each magnetic pole portion includes a first magnet with a magnetization direction that is the radial direction, and a second magnet with a magnetization direction that is inclined circumferentially with respect to the radial direction. The second magnets are arranged symmetrically on the circumferentially outer sides of the first magnet. A first gap is provided between the first magnet and the second magnet in the circumferential direction, and a second gap is provided between the second magnets in the circumferential direction between the adjacent magnetic pole portions. A maximum circumferential width of the second gap is larger than a maximum circumferential width of the first gap.

### CROSS REFERENCE TO RELATED APPLICATIONS

The present application claims priority under 35 U.S.C. § 119 to Japanese Application No. 2024-056667, filed on Mar. 29, 2024, the entire contents of which are hereby incorporated herein by reference.

### 1. FIELD OF THE INVENTION

The present disclosure relates to rotors and rotary electric machines.

### 2. BACKGROUND

A motor in which drive torque is increased by arranging magnets of a rotor in a Halbach array is known.

Since the magnets having different magnetization directions are arranged without a gap in the circumferential direction, there arises a problem that the circumferential dimension of the magnet needs to be manufactured with high accuracy.

### SUMMARY

A rotor according to an example embodiment of the present disclosure is a rotor that is provided in a rotary electric machine, is opposed to a stator, and is rotatable about a central axis. The rotor includes a plurality of magnetic pole portions arranged along a circumferential direction about the central axis, and a rotor core that supports the magnetic pole portions from radial one side. Each of the magnetic pole portions includes a first magnet in which the radial direction is the magnetization direction, and a second magnet in which a direction inclined circumferentially with respect to the radial direction is the magnetization direction. The second magnets are arranged symmetrically with each other on the circumferentially outer sides of the first magnet. A first gap is provided between the first magnet and the second magnet in the circumferential direction, and a second gap is provided between the second magnets in the circumferential direction between the adjacent magnetic pole portions. The maximum circumferential width of the second gap is larger than the maximum circumferential width of the first gap.

A rotary electric machine according to an example embodiment of the present disclosure includes the rotor and a stator located radially outside the rotor.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view illustrating a rotary electric machine of the present example embodiment.

FIG. 2 is a plan view illustrating a portion of a rotor of the present example embodiment.

FIG. 3 is an enlarged plan view of a portion of the rotor of the present example embodiment.

FIG. 4 is a schematic diagram illustrating a flow of magnetic flux.

FIG. 5 is a diagram illustrating a relationship between the distance between second magnets and the counter electromotive voltage constant.

### DETAILED DESCRIPTION

Hereinafter, rotors and rotary electric machines according to example embodiments of the present disclosure will be described with reference to the drawings. The scope of the present disclosure is not limited to the following example embodiments, and may be arbitrarily changed within the scope of the technical idea of the present disclosure. Also note that scales, numbers, and the like of members or portions illustrated in the following drawings may differ from those of actual members or portions, for the sake of easier understanding of the members or portions.

In the following description, an axial direction of a central axis J, that is, a direction parallel to the up-down direction, is simply referred to as “axial”, a radial direction around the central axis J is simply referred to as “radial”, and a circumferential direction around the central axis J is simply referred to as “circumferential”. In the present example embodiment, a lower side (−Z) corresponds to an axial other side, and an upper side (+Z) corresponds to an axial one side. The up-down direction, the upper side, and the lower side simply are names for describing a relative positional relationship of each portion, and an actual arrangement relationship or the like may be an arrangement relationship other than the arrangement relationships indicated by these names.

The up-down direction, the upper side, and the lower side are simply names for describing an arrangement relationship of each portion, and an actual arrangement relationship or the like may be an arrangement relationship other than the arrangement relationship indicated by these names.

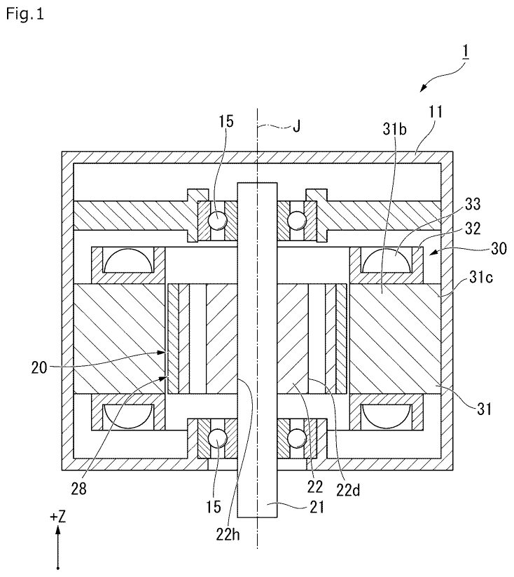

FIG. 1 is a schematic cross-sectional view of a rotary electric machine 1 in a cross-section taken along the central axis J.

The rotary electric machine 1 of the present example embodiment includes a rotor 20, a stator 30, a plurality of bearings 15, and a housing 11 that accommodates them. The bearing 15 rotatably supports a shaft 21 of the rotor 20. The bearing 15 is held by the housing 11.

The rotary electric machine 1 of the present example embodiment is an inner rotor type rotary electric machine in which the rotor 20 is disposed radially inside the stator 30. In the example embodiment described below, the radial inside is assumed to be radial one side, and the radial outside is assumed to be the radial other side. However, the rotary electric machine may be an outer rotor type in which the rotor is disposed radially outside the stator. In this case, the rotary electric machine has a configuration in which the radial one side and other side are reversed in each portion of the rotor.

The stator 30 has an annular shape about the central axis J. The rotor 20 is disposed radially inside the stator 30. The stator 30 is radially opposed to the rotor 20.

The stator 30 includes a stator core 31, an insulator 32, and a plurality of coils 33. The stator core 31 includes a plurality of magnetic members stacked along the axial direction.

The stator core 31 includes a core back 31c having a substantially circular shape and a plurality of teeth 31b. In the present example embodiment, the core back 31c has an annular shape about the central axis J. The teeth 31b extend radially inward from a radially inner surface of the core back 31c. An outer peripheral surface of the core back 31c is fixed with an inner peripheral surface of a peripheral wall portion of the housing 11. The plurality of teeth 31b are arranged at intervals from each other in the circumferential direction on the radially inner surface of the core back 31c. In the present example embodiment, the plurality of teeth 31b are arrayed at equal intervals in the circumferential direction.

The insulator 32 is mounted on the stator core 31. The insulator 32 includes a portion covering the teeth 31b. The material of the insulator 32 is an insulating material such as a resin, for example.

The coil 33 is attached to the stator core 31. The plurality of coils 33 are mounted on the stator core 31 with the insulator 32 interposed therebetween. The plurality of coils 33 are configured by winding a conductive wire around each of the teeth 31b with the insulator 32 interposed therebetween.

The rotor 20 is provided in the rotary electric machine 1 and opposed to the stator 30. The rotor 20 rotates about the central axis J. The rotor 20 includes the shaft 21, a rotor core 22, and a plurality of (eight in the present example embodiment) magnetic pole portions 28 arranged along a circumferential direction on an outer peripheral surface of the rotor core 22. Note that the rotor 20 may further include a cover member having a tubular shape surrounding the entire rotor from the radial outside.

The shaft 21 has a cylindrical shape axially extending about the central axis J. The shaft 21 is rotatably supported by a pair of the bearings 15.

The rotor core 22 has a columnar shape extending axially along the central axis J. The rotor core 22 has a substantially polygonal shape as viewed from the axial direction. The rotor core 22 is made of a ferromagnetic material. The rotor core 22 of the present example embodiment includes a plurality of magnetic members stacked along the axial direction. The rotor core 22 may be made of a non-magnetic material, without being limited to the ferromagnetic material.

The rotor core 22 is provided with a central hole 22h and a lightening hole portion 22d that penetrate axially. The central hole 22h is positioned at the center of the rotor core 22 as viewed from the axial direction. The shaft 21 is inserted into and fixed to the central hole 22h. The lightening hole portion 22d is provided to lighten the rotor core 22 to reduce the weight of the rotor core 22.

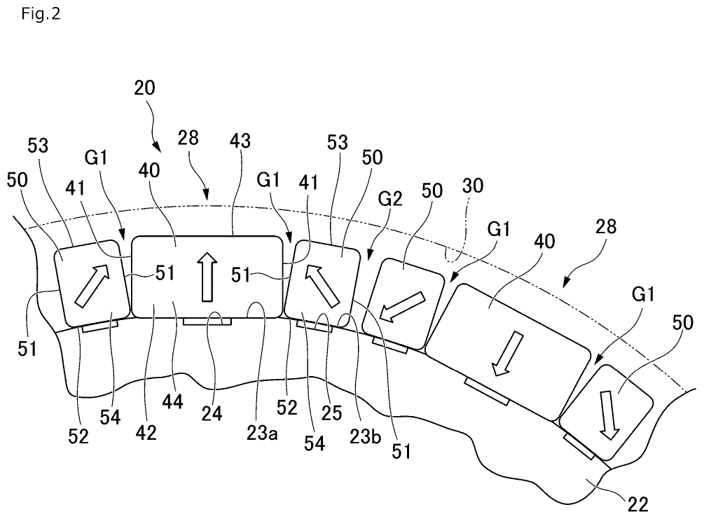

FIG. 2 is a plan view illustrating a part of the rotor 20.

The rotor 20 of the present example embodiment is a surface permanent magnet (SPM) rotor. A first magnet 40 and a second magnet 50 constituting the magnetic pole portion 28 are bonded and fixed to an outer peripheral surface facing radially outward of the rotor core 22. Due to this, the rotor core 22 supports the plurality of magnetic pole portions 28 from radially inside.

The rotor 20 includes the plurality of (twelve in the present example embodiment) magnetic pole portions 28. The plurality of magnetic pole portions 28 are arranged along the circumferential direction about the central axis J. The plurality of magnetic pole portions 28 are arranged at equal intervals along the circumferential direction. The magnetic pole portions 28 circumferentially adjacent to each other have magnetic flux directions inverted from each other in the radial direction. That is, in the magnetic pole portions 28 arranged circumferentially, those with the N poles facing radially outward and those with the S poles facing radially outward are alternately arranged along the circumferential direction.

One magnetic pole portion 28 includes one first magnet 40 and two second magnets 50. The second magnets 50 are arranged symmetrically on the circumferentially outer sides of the first magnet 40. Therefore, the second magnets 50 of the different magnetic pole portions 28 are arranged adjacent to each other at a boundary part between the magnetic pole portions 28 circumferentially adjacent to each other. In the rotor 20, two second magnets 50 are disposed between a pair of the first magnets 40.

The first magnet 40 and the second magnet 50 each have a uniform cross-section and extend in a columnar shape along the axial direction of the central axis J. The upper surfaces of the first magnet 40 and the second magnet 50 form substantially an identical plane. Similarly, the lower surfaces of the first magnet 40 and the second magnet 50 form substantially an identical plane.

In the first magnet 40, the radial direction is the magnetization direction. In the second magnet 50, on the other hand, a direction circumferentially inclined with respect to the radial direction is the magnetization direction. In the second magnet 50, a direction intersecting the radial direction is the magnetization direction. In the second magnet 50 of the present example embodiment, a direction intersecting the radial direction and the circumferential direction is the magnetization direction. As described above, in one magnetic pole portion 28, the pair of second magnets 50 are symmetrically disposed on the circumferentially outer sides with respect to the first magnet 40. Therefore, the magnetization directions of the pair of second magnets 50 are symmetrical to each other with respect to the first magnet 40.

In FIG. 2, arrows illustrated in the first magnet 40 and the second magnet 50 represent magnetization directions of the respective magnets. As illustrated in FIG. 2, the first magnets 40 of the magnetic pole portions 28 circumferentially adjacent to each other have magnetization directions different from each other inside and outside in the radial direction. That is, in the magnetic pole portions 28 circumferentially adjacent to each other, the magnetization directions of the first magnets 40 are inverted from each other. In the second magnet 50 disposed on the circumferential outside of the first magnet 40 in which the radial outside is the magnetization direction, a direction toward the radial outside while approaching the first magnet 40 is the magnetization direction. In the second magnet 50 disposed on the circumferential outside of the first magnet 40 in which the radial inside is the magnetization direction, a direction toward the radial inside while separating from the first magnet 40 is the magnetization direction. In this manner, the first magnet 40 and the second magnet 50 constituting each of the magnetic pole portions 28 are arranged in a Halbach array.

The first magnet 40 has a substantially rectangular shape as viewed from the axial direction. The first magnet 40 includes four side surfaces 41, 41, 42, and 43 extending along the axial direction. The four corner portions of the first magnet 40 are each formed in a tapered shape or an arc shape and do not have a vertex.

The first magnet 40 has a pair of first magnet side surfaces 41 facing the circumferential direction, a first supported surface 42 facing the radial inside, and a first magnet opposed surface 43 facing the radial outside. Among the four side surfaces 41, 41, 42, and 43 of the first magnet 40, the pair of first magnet side surfaces 41 and the first supported surface 42 are flat surfaces. The first supported surface 42 intersects the first magnet side surfaces 41 and 41 at a right angle. Since the first supported surface 42 intersects the first magnet side surfaces 41 and 41 at a right angle, for example, the first magnet 40 can be easily manufactured as compared with the case where the first magnet side surfaces 41 and 41 extend in the radial direction when viewed from the axial direction and are not parallel.

The first magnet 40 includes a first magnet supported portion 44 including the first supported surface 42. The first magnet supported portion 44 is a region having a predetermined thickness dimension radially outward from the first supported surface 42 with a thickness along the radial direction of the first magnet 40, and is a portion supported with respect to the rotor core 22.

The pair of first magnet side surfaces 41 face opposite sides to each other in the circumferential direction. That is, each of the first magnet side surfaces 41 faces circumferentially outward in the first magnet 40. The first magnet side surface 41 is a flat surface parallel to a straight line located at the center in the circumferential direction of the first magnet 40 and extending in the radial direction when viewed from the axial direction. The pair of first magnet side surfaces 41 of the present example embodiment are parallel to each other. Therefore, the first magnet side surfaces 41 are slightly inclined with respect to the radial direction. Note that the first magnet side surfaces 41 may be flat surfaces that completely coincide with the radial direction.

The first supported surface 42 is a flat surface orthogonal to the radial direction. The first supported surface 42 is opposed to, comes into contact with, and is supported by the rotor core 22. The rotor core 22 has a first support surface 23a. The circumferential length of the first support surface 23a is substantially equal to the circumferential length of the first supported surface 42. The first support surface 23a is opposed to and comes into contact with the first supported surface 42.

The first support surface 23a is provided with a first groove 24 recessed radially inward. The first groove 24 is filled with an adhesive. Therefore, the first supported surface 42 is fixed to the first support surface 23a via the adhesive with which the first groove 24 is filled. As a result, in the first magnet 40, the first magnet supported portion 44 is fixed to the rotor core 22.

The first magnet opposed surface 43 is opposed to the stator 30. The first magnet opposed surface 43 is a gentle curved surface having a constant distance to the central axis J. Therefore, the thickness dimension along the radial direction of the first magnet 40 is the largest at the circumferential center and decreases toward circumferential both sides. In the present example embodiment, the first magnet opposed surface 43 is an arc surface having a constant curvature radius.

The second magnet 50 has a substantially rectangular shape as viewed from the axial direction. The second magnet 50 includes four side surfaces 51, 51, 52, and 53 extending along the axial direction. That is, the second magnet 50 has a pair of second magnet side surfaces 51 facing the circumferential direction, a second supported surface 52 facing the radial inside, and a second magnet opposed surface 53 facing the radial outside. The four side surfaces 51, 51, 52, and 53 of the second magnet 50 are all flat surfaces. The four corner portions of the second magnet 50 are each formed in a tapered shape or an arc shape and do not have a vertex. The four side surfaces 51, 51, 52, and 53 intersect at a right angle when viewed from the axial direction. That is, the second magnet 50 has a substantially rectangular quadrangular shape when viewed from the axial direction.

Since the second magnet 50 has a substantially rectangular shape when viewed from the axial direction, for example, the second magnet 50 can be easily manufactured as compared with the case where the second magnet 50 does not have a rectangular shape when viewed from the axial direction.

The second magnet 50 includes a second magnet supported portion 54 including the second supported surface 52. The second magnet supported portion 54 is a region having a predetermined thickness dimension radially outward from the second supported surface 52 with a thickness along the radial direction of the second magnet 50, and is a portion supported with respect to the rotor core 22.

The pair of second magnet side surfaces 51 face opposite sides to each other in the circumferential direction. That is, each of the second magnet side surfaces 51 faces circumferentially outward in the second magnet 50. The second magnet side surface 51 is a flat surface parallel to a straight line located at the center in the circumferential direction of the second magnet 50 and extending in the radial direction when viewed from the axial direction. The pair of second magnet side surfaces 51 of the present example embodiment are parallel to each other. Therefore, the second magnet side surfaces 51 are slightly inclined with respect to the radial direction. Note that the second magnet side surfaces 51 may be flat surfaces that completely coincide with the radial direction.

The second supported surface 52 is a flat surface orthogonal to the radial direction. The second supported surface 52 is opposed to, comes into contact with, and is supported by the rotor core 22. The rotor core 22 has a second support surface 23b. The circumferential length of the second support surface 23b is substantially equal to the circumferential length of the second supported surface 52. The second support surface 23b is opposed to and comes into contact with the second supported surface 52.

The second support surface 23b is provided with a second groove 25 recessed radially inward. The second groove 25 is filled with an adhesive. Therefore, the second supported surface 52 is fixed to the second support surface 23b via the adhesive with which the second groove 25 is filled. As a result, in the second magnet 50, the second magnet supported portion 54 is fixed to the rotor core 22.

The second magnet opposed surface 53 is opposed to the stator 30. The second magnet opposed surface 53 is a flat surface orthogonal to the radial direction.

A first gap G1 is provided between the first magnet 40 and the second magnet 50 in the circumferential direction. A second gap G2 is provided between the second magnets 50 in the circumferential direction between the adjacent magnetic pole portions 28. By providing the second gap G2 between the second magnets 50 of the adjacent magnetic pole portions 28, it is possible to reduce the leakage magnetic flux from the second magnet 50 of one magnetic pole portion 28 to the second magnet 50 of another adjacent magnetic pole portion 28.

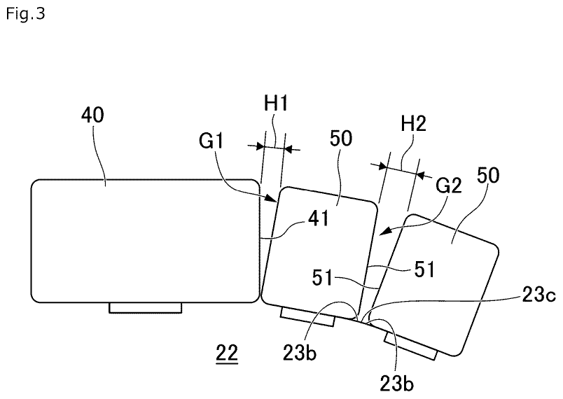

The maximum width of the first gap G1 and the maximum width of the second gap G2 increase toward the outside in the radial direction. As illustrated in FIG. 3, a second dimension H2 indicating the maximum circumferential width of the second gap G2 is larger than a first dimension H1 indicating the maximum circumferential width of the first gap G1. Since the second dimension H2 is larger than the first dimension H1, the magnetic flux flowing from the second magnet 50 to the first magnet 40 in the magnetic pole portion 28 can be increased, and a decrease in the efficiency of the motor can be suppressed.

The first magnet 40 and the second magnet 50 have portions partially in contact with each other. In the first magnet 40 and the second magnet 50, the radially inner ends of the first magnet side surface 41 and the second magnet side surface 51 opposed to each other in the circumferential direction are in contact with each other. Since the first magnet 40 and the second magnet 50 have portions partially in contact with each other, the magnetic flux flowing through the first magnet 40 can be increased as compared with the case where there is no portion in contact with each other.

In the second gap G2, the second support surface 23b is exposed as the rotor core 22. In the second gap G2, both the second support surface 23b that supports the second magnet 50 in one magnetic pole portion 28 and the second support surface 23b that supports the second magnet 50 of another magnetic pole portion 28 adjacent to the one magnetic pole portion 28 are exposed. Between the magnetic pole portions 28 adjacent to each other in the circumferential direction, a ridge line 23c is provided at an intersection between the second support surfaces 23b supporting the second supported surfaces 52 in the opposed second magnets 50. The ridge line 23c is exposed to the second gap G2.

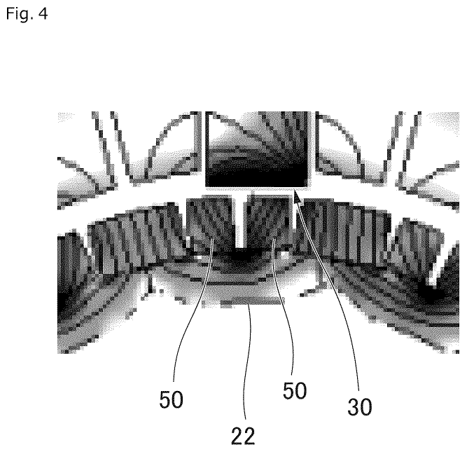

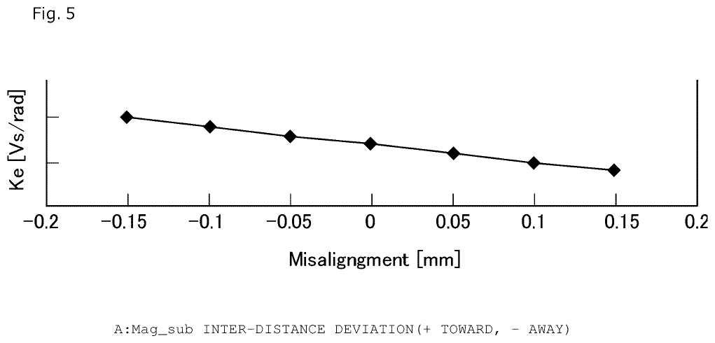

In the rotor 20 and the rotary electric machine 1 having the above configuration, the second gap G2 is provided between the second magnets 50 of the adjacent magnetic pole portions 28, so that the magnetic short circuit between the second magnets 50 is reduced and the effective magnetic flux flowing into the stator is increased as illustrated in FIG. 4. As a result, as shown in FIG. 5, the larger the distance between the second magnets 50, the higher the counter electromotive voltage constant [Ke], and the higher the power density becomes.

As described above, in the rotor 20 and the rotary electric machine 1 of the present example embodiment, the first gap G1 is provided between the first magnet 40 and the second magnet 50, the second gap G2 is provided between the second magnets 50 in the circumferential direction between the adjacent magnetic pole portions 28, and the maximum width of the second gap G2 in the circumferential direction is larger than the maximum width of the first gap G1 in the circumferential direction. Therefore, it is possible to increase the power density without arranging the first magnet 40 and the second magnet 50 without a gap in the circumferential direction.

Therefore, in the rotor 20 and the rotary electric machine 1 of the present example embodiment, it is not necessary to manufacture the circumferential dimensions of the first magnet 40 and the second magnet 50 with high accuracy, so that it is possible to manufacture them easily.

Furthermore, in the rotor 20 and the rotary electric machine 1 of the present example embodiment, since the second magnet 50 has a quadrangular cross section orthogonal to the central axis J, the second magnet 50 can be easily manufactured as compared with the case where the second magnet 50 is not quadrangular.

In the rotor 20 and the rotary electric machine 1 of the present example embodiment, the first magnet 40 and the second magnet 50 have portions partially in contact with each other, so that the magnetic flux flowing through the first magnet 40 can be increased as compared with the case where there is no portion in contact with each other.

In the rotor 20 and the rotary electric machine 1 of the present example embodiment, the first support surface 23a of the rotor core 22 is provided with the first groove 24 to be filled with an adhesive with respect to the first supported surface 42 of the first magnet 40, and the second support surface 23b of the rotor core 22 is provided with the second groove 25 to be filled with an adhesive with respect to the second supported surface 52 of the second magnet 50. Thus, the first supported surface 42 of the first magnet 40 can be reliably fixed to the first support surface 23a via the adhesive with which the first groove 24 is filled, and the second supported surface 52 of the second magnet 50 can be reliably fixed to the second support surface 23b via the adhesive with which the second groove 25 is filled.

While example embodiments of the present disclosure have been described above with reference to the accompanying drawings, the present disclosure is not limited to such examples. Various shapes, combinations, and the like of the constituent members in the above example embodiments are only by way of example, and various modifications are possible based on design requirements and the like without departing from the gist of the present disclosure.

For example, the shapes of the magnets and the shapes of the outer cores are not limited to the examples described in the above-described example embodiments and modifications. The number of poles of the rotor and the number of slots of the stator are not limited to those of the above-described example embodiments.

In the above-described example embodiments, the case where the present disclosure is applied to a surface permanent magnet (SPM) rotor has been described. However, the present disclosure may be applied to an interior permanent magnet (IPM) rotor.

The rotary electric machine to which example embodiments of the present disclosure is applied is not limited to a motor, and may be a generator. In this case, the rotary electric machine may be a three-phase AC generator. Application of the rotary electric machine is not particularly limited. For example, the rotary electric machine may be mounted on a vehicle or may be mounted on equipment other than a vehicle. The number of poles and the number of slots of the rotary electric machine are not particularly limited. In the rotary electric machine, the coil may be configured by any winding method.

Features of the above-described example embodiments and the modifications thereof may be combined appropriately as long as no conflict arises.

Note that the present technique can have a configuration as described below.

(1) A rotor that is provided in a rotary electric machine, is opposed to a stator, and is rotatable about a central axis, the rotor including magnetic pole portions arranged along a circumferential direction about the central axis, and a rotor core that supports the magnetic pole portions from one radial side, wherein each of the magnetic pole portions includes a first magnet in which a radial direction is a magnetization direction, and a second magnet in which a direction inclined circumferentially with respect to the radial direction is a magnetization direction, the second magnets being arranged symmetrically with each other on circumferentially outer sides of the first magnet, a first gap is provided between the first magnet and the second magnet in the circumferential direction, a second gap is provided between the second magnets in the circumferential direction between the magnetic pole portions adjacent to each other, and a maximum width of the second gap in the circumferential direction is larger than a maximum width of the first gap in the circumferential direction.

(2) The rotor according to (1), wherein the maximum width of the first gap and the maximum width of the second gap increase toward outside in the radial direction.

(3) The rotor according to (2), wherein the first magnet and the second magnet include portions partially in contact with each other.

(4) The rotor according to any one of (1) to (3), wherein the second magnet has a quadrangular cross section orthogonal to the central axis.

(5) The rotor according to any one of (1) to (4), wherein the first magnet includes a first supported surface directed radially inward, the second magnet includes a second supported surface directed radially inward, and the rotor core includes a first support surface that supports the first supported surface, and a second support surface that supports the second supported surface.

(6) The rotor according to (5), wherein the first support surface is provided with a first groove to be filled with an adhesive between the first support surface and the first supported surface, and the second support surface is provided with a second groove to be filled with an adhesive between the second support surface and the second supported surface.

(7) The rotor according to (6), wherein the second support surface is a plane orthogonal to the radial direction, a ridge line is provided at an intersection of the second support surfaces supporting the second supported surfaces of the second magnets of the magnetic pole portions adjacent to each other, and the ridge line is exposed to the second gap.

(8) A rotary electric machine including the rotor according to any one of (1) to (7), and a stator opposed to the rotor.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotor that is provided in a rotary electric machine, is opposed to a stator, and is rotatable about a central axis, the rotor comprising:
magnetic pole portions arranged along a circumferential direction about the central axis; and
a rotor core that supports the magnetic pole portions from one radial side; wherein
each of the magnetic pole portions includes:
a first magnet in which the radial direction is a magnetization direction; and
a second magnet in which a direction inclined circumferentially with respect to the radial direction is a magnetization direction, the second magnets being arranged symmetrically with each other on circumferentially outer sides of the first magnet;
a first gap is provided between the first magnet and the second magnet in the circumferential direction;
a second gap is provided between the second magnets in the circumferential direction between the magnetic pole portions adjacent to each other; and
a maximum width of the second gap in the circumferential direction is larger than a maximum width of the first gap in the circumferential direction.

2. The rotor according to claim 1, wherein the maximum width of the first gap and the maximum width of the second gap increase toward outside in the radial direction.

3. The rotor according to claim 1, wherein the first magnet and the second magnet include portions partially in contact with each other.

4. The rotor according to claim 1, wherein the second magnet has a quadrangular cross section orthogonal to the central axis.

5. The rotor according to claim 1, wherein
the first magnet includes a first supported surface directed radially inward;
the second magnet includes a second supported surface directed radially inward; and
the rotor core includes:
a first support surface that supports the first supported surface; and
a second support surface that supports the second supported surface.

6. The rotor according to claim 5, wherein
the first support surface is provided with a first groove to be filled with an adhesive between the first support surface and the first supported surface; and
the second support surface is provided with a second groove to be filled with an adhesive between the second support surface and the second supported surface.

7. The rotor according to claim 5, wherein
the second support surface is a plane orthogonal to the radial direction;
a ridge line is provided at an intersection of the second support surfaces supporting the second supported surfaces of the second magnets of the magnetic pole portions adjacent to each other; and
the ridge line is exposed to the second gap.

8. A rotary electric machine comprising:
the rotor according to claim 1; and
a stator opposed to the rotor.
